(19) United States
(12) Patent Application Publication
(10) Pub. No.: US 2011/0112995 A1
(43) Pub. Date: May 12, 2011

(54) Systems and methods for organizing collective social intelligence information using an organic object data model

(75) Inventors: Chu-Fei Chang, Tainan City (TW); Tai-Ting Wu, Zhubei City (TW); Chun-Wei Lin, Daxi Township (TW); Chia-Hao Lo, Xizhi City (TW); Tao-Yang Fu, Taipei City (TW)

(73) Assignee: Industrial Technology Research Institute

(21) Appl. No.: 12/801,777

(22) Filed: Jun. 24, 2010

Related U.S. Application Data
(60) Provisional application No. 61/255,494, filed on Oct. 28, 2009.

(51) Int. Cl. G06N 5/02; G06F 15/18

(52) U.S. Cl. 706/12; 706/50

(57) ABSTRACT

A method for capturing and organizing intelligence data using an organic data model includes: receiving one or more webpages containing social intelligence data; segmenting content of the one or more webpages containing social intelligence data; identifying named entities in the segmented content of the one or more webpages; identifying topics in the segmented content of the one or more webpages; identifying opinions in the segmented content of the one or more webpages; integrating the identified named entities, topics, and opinions to construct an organic object data model; and storing organic object data associated with the constructed organic object data model in an organic object database.

### PRIORITY

This application claims the benefit of priority of U.S. Provisional Application No. 61/255,494, filed Oct. 28, 2009, which is incorporated by reference herein in its entirety for any purpose.

### TECHNICAL FIELD

The present disclosure relates to the field of capturing and analyzing online collective intelligence information and, more particularly, to systems and methods for collecting and managing data collected from online social communities and using an organic object architecture to provide high quality search results.

### BACKGROUND

A Web 2.0 site allows its users to interact with each other as contributors to the website's content, in contrast to websites where users are limited to the passive viewing of information that is provided to them. The ability to create and update content leads to the collaborative work of many rather than just a few web authors. For example, in wikis, users may extend, undo, and redo each other's work. In blogs, posts and the comments of individuals build up over time.

Social intelligence (SI) refers to the notion of analyzing data collected from a group of internet users that allows visibility into opinions and past and future behaviors in the social group. For an online search engine to provide responsive online search results, it is necessary for the search system to effectively capture and manage the SI information from various sources.

One of the most commonly used online search methods used among Web 2.0 sites is keyword search. However, keyword search has a number of shortcomings. It is prone to being over-inclusive, i.e., finding non-relevant documents, and under-inclusive, i.e., not finding certain relevant documents. Also, the results from keyword searches often do not distinguish the same keywords within different contexts. As such, an internet user may need to spend minutes or even hours to scan the search results to identify useful information. These shortcomings of keyword search are even more pronounced when dealing with a large volume of SI information.

The disclosed embodiments are directed to managing collected social intelligence information by using an organic object data model to facilitate effective online searches and to overcome one or more of the problems set forth above.

### SUMMARY

In one aspect, the present disclosure is directed to a method for capturing and organizing data collected online using an organic object data model. The disclosed method includes: receiving one or more webpages containing social intelligence data; segmenting content of the one or more webpages containing social intelligence data; identifying named entities in the segmented content of the one or more webpages; identifying topics in the segmented content of the one or more webpages; identifying opinions in the segmented content of the one or more webpages; integrating the identified named entities, topics, and opinions to construct an organic object data model; and storing organic object data associated with the constructed organic object data model in an organic object database.

In another aspect, the present disclosure is directed to a system for capturing and organizing social intelligence data collected online, the system being implemented by one or more computer processors executing computer programs stored on computer readable storage media. The system includes: a segmentation and integration module coupled to a training database, the segmentation and integration module configured to receiving webpages containing social intelligence data; an object recognition module coupled to the segmentation and integration module, the object integration module configured to identify named entities contained in the received webpages; a topic classification and identification module coupled to the segmentation and integration module, the topics classification and identification module configured to identify topics for each sentence and paragraph of the received webpages; an opinion mining and sentiment analysis module coupled to the segmentation and integration module, the opinion mining and sentiment analysis module configured to determine opinions in sentences of the received webpages and opinions associated with the identified named entities; and an object relationship construction module coupled to the segmentation and integration module, the object relation construction module configured to define relationships between named entities.

In yet another aspect, the present disclosure is directed to a system for capturing and organizing social intelligence data collected online. The system may be implemented by one or more computer processors executing computer programs stored on computer readable storage media. The system includes: a segmentation and integration module coupled to a training database, the segmentation and integration module configured to receive webpages containing social intelligence data and support an organic object model including an organic object, self-producing attributes associated with the organic object, domain-specific attributes associated with the organic object, and social attributes associated with the organic object; an object recognition module coupled to the segmentation and integration module, the object integration module configured to identify named entities contained in the received webpages, wherein the determined named entities are organic objects; a topic classification and identification module coupled to the segmentation and integration module, the topics classification and identification module configured to identify topics for each sentence and paragraph of the received webpages, wherein the identified topics are social attributes associated with their corresponding organic objects; an opinion mining and sentiment analysis module coupled to the segmentation and integration module, the opinion mining and sentiment analysis module configured to determine opinions in sentences of the received webpages and opinions associated with identified named entities, wherein the identified opinions are social attributes associated with their corresponding organic objects; and an object relationship construction module coupled to the segmentation and integration module, the object relationship construction module configured to define relationships between organic objects.

4

### BRIEF DESCRIPTION OF THE DRAWINGS

FIG. 1a is a block diagram of an exemplary online search engine hardware architecture.

FIG. 1b is a block diagram of an exemplary organic object data model.

FIG. 2 is a block diagram of an exemplary organic data object.

FIG. 3 is a block diagram of an exemplary information capture and management system based on the organic object data model.

FIG. 4 is a flow chart of an exemplary process of an object recognition module of the exemplary information capture and management system shown in FIG. 3.

FIG. 5 is a flow chart illustrating an exemplary process of applying an N-gram merge algorithm by the object recognition module shown in FIG. 3.

FIG. 6 is a diagram of an exemplary process applying the N-gram merge algorithm.

FIG. 7 is a diagram illustrating the calculation of a reliance value used in the object recognition module.

FIG. 8 is a block diagram of an exemplary topic classification and identification module shown in FIG. 3.

FIG. 9 shows an exemplary calculation of semantic similarity applied by the exemplary topic classification and identification module.

FIG. 10 is a flow chart of an exemplary process for collecting and improving the quality of training data implemented by the exemplary topic classification and identification module.

FIG. 11 is a block diagram providing further illustration of the exemplary process for collecting and improving the quality of training data implemented by the exemplary topic classification and identification module.

FIG. 12a is a block diagram of an exemplary opinion mining and sentiment analysis module shown in FIG. 3.

FIG. 12b is a block diagram illustrating the testing process implemented by the exemplary opinion mining and sentiment analysis module.

FIG. 12c is a block diagram of an exemplary architecture that may be used to implement a topic classification and identification module and an opinion mining and sentiment analysis module.

FIG. 13 is a block diagram of an exemplary segmentation and integration module shown in FIG. 3.

### DETAILED DESCRIPTION

Systems and methods disclosed herein capture and manage collected social intelligence information in order to provide faster and more accurate online search results in response to user inquiries. The disclosed embodiments use an organic object data model to provide a framework for capturing and analyzing information collected from online social networks and other online communities, as well as other webpages. The organic object data model reflects the heterogeneous nature of the intelligence information created by online social networks and communities. By applying the organic object data model, the disclosed information capture and management system may efficiently categorize a large volume of information and present the sought-after information upon request.

Embodiments of the disclosure include software modules and databases that may be implemented by various configurations of computer software and hardware components. Each software and hardware configuration may require configurations of various computer storage media, various computers designed or configured to perform certain disclosed functions, various third-party software applications, and software applications implementing the disclosed system functionalities.

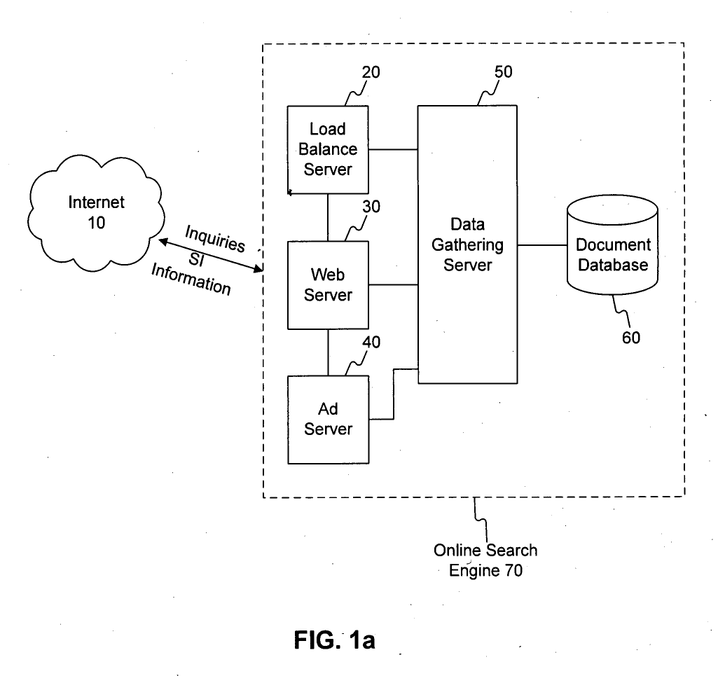

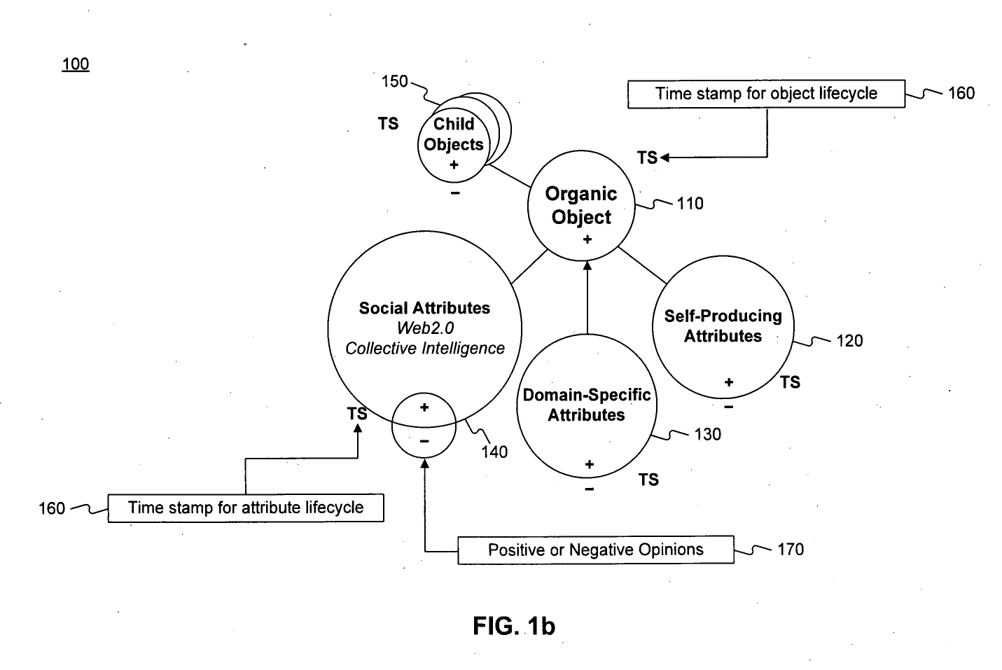

FIG. 1 a is a block diagram showing an exemplary hardware architecture of an online search engine 70. Online search engine 70 may refer to any software and hardware that are configured to provide search results of online content upon receiving user search requests. A well known example of an online search engine is the Google search engine. As shown in FIG. 1a, online search engine 70 may receive user inquires, such as search requests, from internet 10. Online search engine 70 may also collect SI information from online social groups. Online search engine 70 may be implemented using one or more servers, such as one or more 2×300 MHz Dual Pentium II servers produced by Intel. A server may refer to a computer running a server operating system, but may also refer to any software or dedicated hardware capable of providing services.

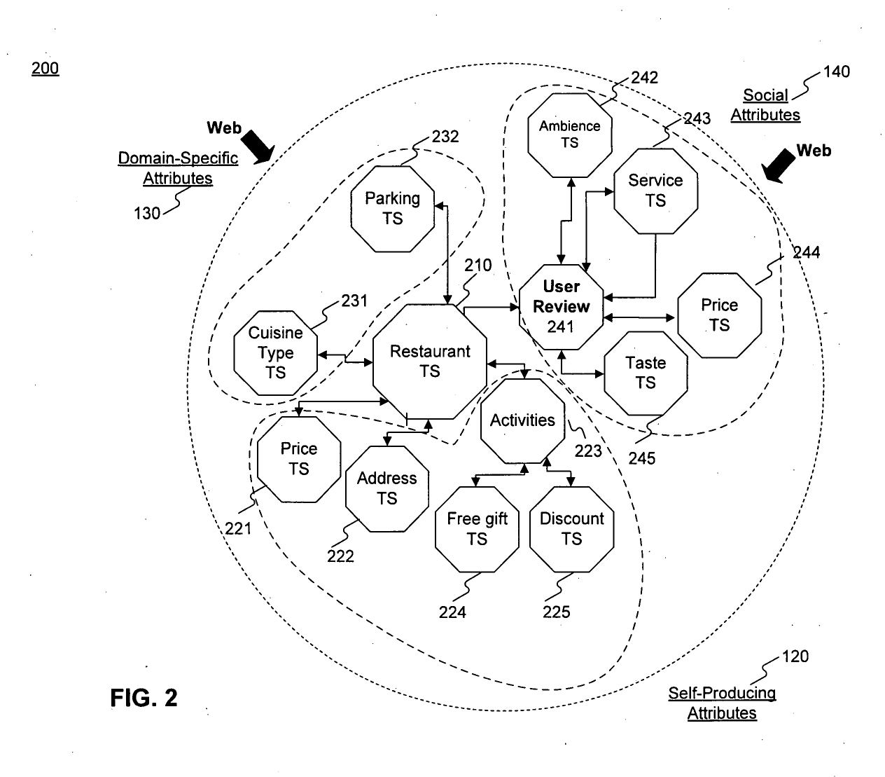

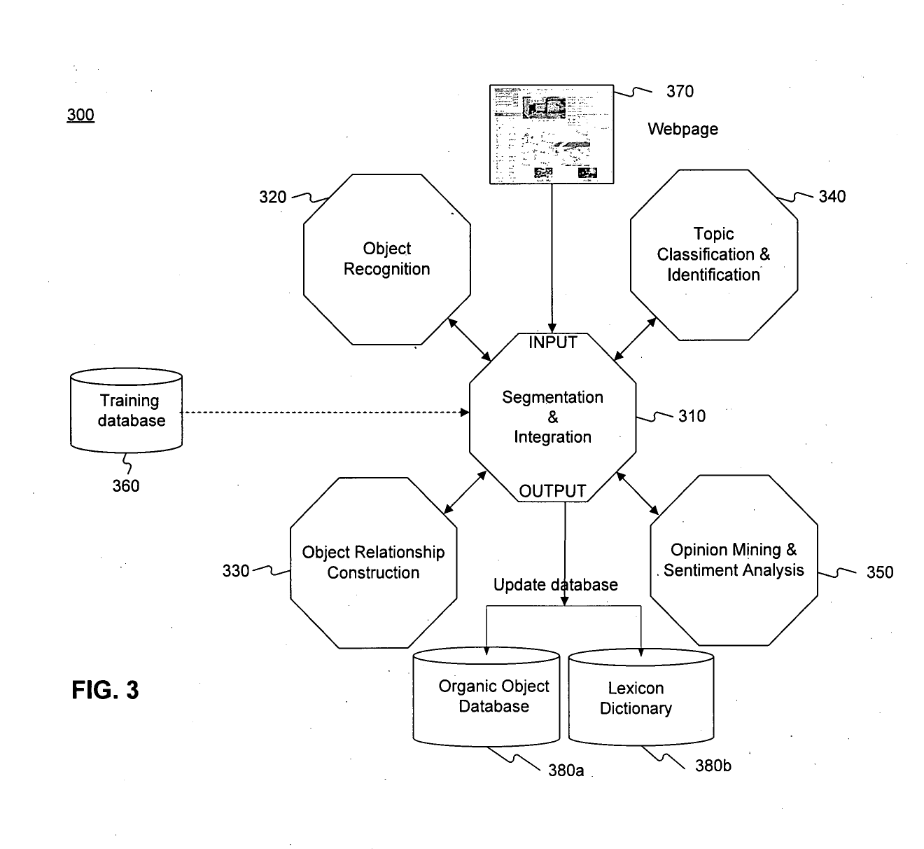

Online search engine 70 may include one or more load balancing servers 20, which may receive search requests from internet 10 and forward the requests to one of web servers 30. Web servers 30 may coordinate the execution of queries received from internet 10, format the corresponding search results received from a data gathering server 50, retrieve a list of advertisements from an Ad server 40, and generate the search result in response to a user's search request received from internet 10. Ad server 40 may manage advertisements associated with online search engine 70. Data gathering server 50 may collect SI information from internet 10 and organize the collected data by indexing data or using various data structures. Data gathering server 50 may store and retrieve organized data from a document database 60. In one example, data gathering server 50 may host an information capture and management system based on an organic object data model. The organic object data model is further disclosed in relation to FIGS. 1b and 2. An exemplary information capture and management system is further disclosed in relation to FIG. 3.

FIG. 1b is a block diagram of an exemplary organic object data model 100. As shown in FIG. 1b, an organic object 110 may be a named entity (e.g., a named restaurant) with child objects 150. A child object 150 may be a named entity that inherits the properties of its parent object 110. Organic object 110 may have at least three types of attributes: self-producing attributes 120, domain-specific attributes 130, and social attributes 140. Self-producing attributes 120 may include attributes generated by object 110 itself Domain-specific attributes 130 may include attributes describing the subject matter area of object 110. Social attributes 140 may include categorized intelligence information contributed by online social groups related to object 110. In one example, the intelligence information contributed by online social groups may be user opinions, such as positive or negative opinions 170 about object 110 or its attributes. Each category of the categorized intelligence information may be a topic associated with one or more opinions. A topic may also be a social attribute.

Organic object 110 may include a time stamp 160 (TS 160), which may associate object 110 with a period of time or an instance of time. TS 160 may indicate the object lifecycle, which may be the time period between the creation and the deletion of object 110, or alternatively, the effective time period of object 110. In another example, TS 160 may refer to the time of creation of an information entry related to object 110. As shown in FIG. 1b, all attributes (120, 130, and 140) and child objects (150) associated with object 110 may also have time stamps associated with them.

FIG. 2 provides an example of an organic object 200. As shown in FIG. 2, a named restaurant 210 (e.g., McDonalds) may be an organic object. Child objects (not shown in FIG. 2) of restaurant 210 may include, for example, different types of food served in restaurant 210, such as burgers, French fries, etc. Self producing attributes 120 of organic object restaurant 210 may include information such as an address 222 of restaurant 210, prices 221 set by restaurant 210, and promotional activities 223 of restaurant 210, such as free gifts 224 and discounts 225. Domain-specific attributes 130 of restaurant 210 may include type of cuisine 231 served by restaurant 210, parking space 232 of restaurant 210, etc. Social attributes 140 of restaurant 210 may include user reviews 241 of restaurant 210, user opinions on topics such as ambience 242, service 243, price 244, and taste of food 245. The user opinions may be negative (e.g., the price is too expensive) or positive (e.g., the service is excellent). As shown in FIG. 2, an attribute may be associated with a time stamp (TS) to indicate its effective time.

FIG. 3 shows an exemplary information capture and management system 300 for capturing information from the interne and organizing the information using the organic object model. Information capture and management system 300 may collect social intelligence information provided by online social networks and other communities, categorize and store the collected social intelligence information by applying the organic object data model. Information capture and management system 300 may receive user inquiries searching for certain information (e.g., restaurant reviews of a specific restaurant). Information capture and management system 300 may respond to the user inquires by retrieving information captured and organized based on the organic object model.

Information capture and management system 300 may include a segmentation and integration module 310, an object recognition module 320, an object relation construction module 330, a topic classification and identification module 340, and an opinion mining and sentiment analysis module 350. Information capture and management system 300 may further include a training database 360 an organic object database 380a, and a lexicon dictionary 380b. Training database 360 may store data records such as NEs (named entities), topics or topic patterns, opinion words, and opinion patterns. Training database 360 may provide training datasets for object recognition module 320, topic and classification and identification module 340, and opinion mining and sentiment analysis module 350 to facilitate machine learning processes. Training database 360 may receive training data from object recognition module 320, topic and classification and identification module 340, and opinion mining and sentiment analysis module 350 to facilitate the machine learning processes. Organic object database 380a may store organic objects (e.g., 200 in FIG. 2). Lexicon dictionary 380b may store recognized NEs (organic objects), topics (social attributes), topics patterns (social attributes), opinions (social attributes), and opinion patterns (social attributes) and other information categorized by one or more modules of information capture and management system 300.

Segmentation and integration module 310 may receive a webpage 370 from the internet. Webpage 370 may be any webpage collected from an online social community, which contains social intelligence data. Segmentation and integration module 310 may further segment the content in webpage 370 and identify boundaries of lexicons in each sentence. For example, one difference between Chinese and English is that lexicons in a Chinese sentence do not have clear boundaries. As such, before processing any Chinese language content from webpages 370, segmentation and integration module 310 may need to first segment the lexicons in a sentence. A traditional method for segmenting text is using plug-in modules containing various language patterns/grammatical rules to assist software applications with text segmentation. One of the improved algorithms used in segmenting text is the linear-chain Conditional Random Field (CRF) algorithm, which has been used in Chinese word segmentation.

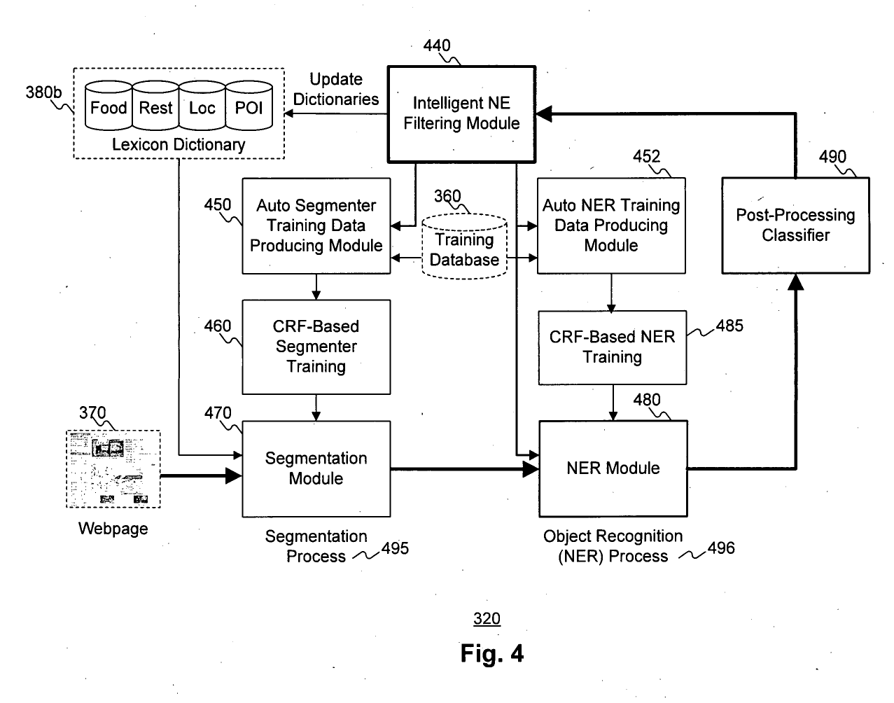

One shortcoming of the CRF method is that it does not perform well when dealing with fast changing input data. Social intelligence information provided by online social networks and communities, however, are fast changing data. As such, the disclosed embodiments of segmentation and integration module 310 may use an improved machine learning method, which benefits from the machine learning functions of other modules (object recognition module 320, topic classification and identification module 340, and opinion mining module 350) to implement improved machine learning and word segmentation processes. An exemplary improved machine learning process is further disclosed in FIGS. 4-13 below.

In one example, training database 360 may be updated by the training processes in object recognition module 320, topic classification and identification module 340, and opinion mining module 350 to improve the quality of the training data. High quality training data from training database 360 may improve the accuracy of segmentations performed by segmentation and integration module 310.

FIG. 4 shows an exemplary object recognition module 320. Object recognition module 320 may identify NEs, classify the identified NEs, and store the classified NEs in lexicon dictionary 380b. Lexicon dictionary 380b may contain a plurality of named entity lexicons such as food NEs, restaurant NEs, and location NEs. A segmentation process 495 and an Object Recognition (NER) process 496 each may include two processes: a learning process and a testing process. During the learning process, a module of information capture and management system 300 (e.g., a training module) may read labeled data from a training database, such as database 360, and compute parameters for machine learning related mathematic models. During the learning process, the training module may also configure a classifier based on the calculated parameters and the mathematical model related to machine learning. A classifier may refer to a software module that maps sets of input data into classes based on one or more attributes of the input data. For example, a class may refer to a topic, an opinion, or any other classification based on one or more attributes of input data. A module of information capture and management system 300 (i.e., a testing module) may then use the classifier to test new data, which may be referred to as a testing process. During the testing process, the testing module may label newly read data as different NEs, such as a restaurant, a type of food, or a location. Training database 360 may contain domain-specific training documents which may be labeled for different NEs.

As shown in FIG. 4, object recognition module 320 may retrieve data from lexicon dictionary 380b and training database 360. A segmentation process 495 may include an auto segmenter training data producing module 450, a CRF-based segmenter training module 460, and a segmenter testing module 470. Segmentation process 495 may be implemented as part of segmentation and integration module 310, or alternatively, as part of object recognition module 320. When information capture and management system 300 retrieves webpage 370, system 300 first executes segmentation process 495 to segment the content of webpage 370. System 300 then executes a named object recognition process 496 in object recognition module 320 to identify NEs in the content.

Next, object recognition module 320 may use a post-processing classifier 490 to categorize recognized NEs. Post-processing classifier 490 may use the context of the sentence around the NEs to decide NE classes. For example, webpage 370 may contain a number of restaurant reviews discussing various entries at a number of restaurants at different locations. Post-processing classifier 490 may classify the recognized NEs into at least three classes of entities: food, restaurant, and location.

As shown in FIG. 4, both segmentation process 495 and object recognition process 496 include an auto training data producing module (450 and 452). Auto training data producing modules 450 and 452 may receive recognized NEs from intelligent NE filtering module 440 and store the received NEs in training database 360. Auto training data producing modules 450 and 452 may also access the NEs stored in training database 360 and send the retrieved NEs to training modules 460 and 485. Both segmentation process 495 and object recognition process 496 include Conditional Random Field based (CRF-based) training modules 460 and 485. Further, the CRF-based training modules 460 and 485 may apply an N-gram based NE recognition training. CRF refers to a type of discriminative probabilistic model often used for the labeling or parsing of sequential data, such as natural language text or biological sequences. An n-gram refers to a subsequence of n items (e.g., letters, syllables, etc.) from a given sequence.

Also, both segmentation process 495 and object recognition process 496 may use training data from training database 360 to train segmenter training module 460 and NE recognition training module 485 to better identify NEs. The quality of the training data in database 360, such as the completeness and the balance (even distribution of data across classes) of the training datasets, may thus affect the performance of modules 310 and 320 (FIG. 3). The quality of the training data may be measured by the precision and recall values achieved by each module.

After repeating the training processes, the CRF-based segmentation or NE recognition may achieve a high level of precision and completeness. Segmentation module 470 may then segment the content in webpage 370 and send the segmented content to an NE recognition (NER) module 480. NE recognition module 480 may include parallel recognition sub-modules. For example, each recognition sub-module may identify one class of NEs. If NEs include three classes of NEs, such as food, restaurant, and location, NE recognition module 480 may implement three sub-modules to identify NEs of each class (food names, restaurant names, and locations). NE recognition module 480 may then identify NEs and then send the NEs to post-processing classifier 490.

If the output from NE recognition module 480 is indefinite, post-processing classifier 490 may then arbitrate the results. For example, if two NE recognition sub-modules (e.g., one for food and one for restaurant) each maps one NE (e.g., ravioli) into an organic object data model, post-processing classifier 490 may then use the sentence context around the NE to decide its correct class (e.g., whether “ravioli” refers to the food itself, or one dish served by the restaurant in a sentence). Post-processing classifier 490 may categorize the NEs into classes (e.g., food names, restaurant names, and locations) and send identified NEs to intelligent NE filtering module 440.

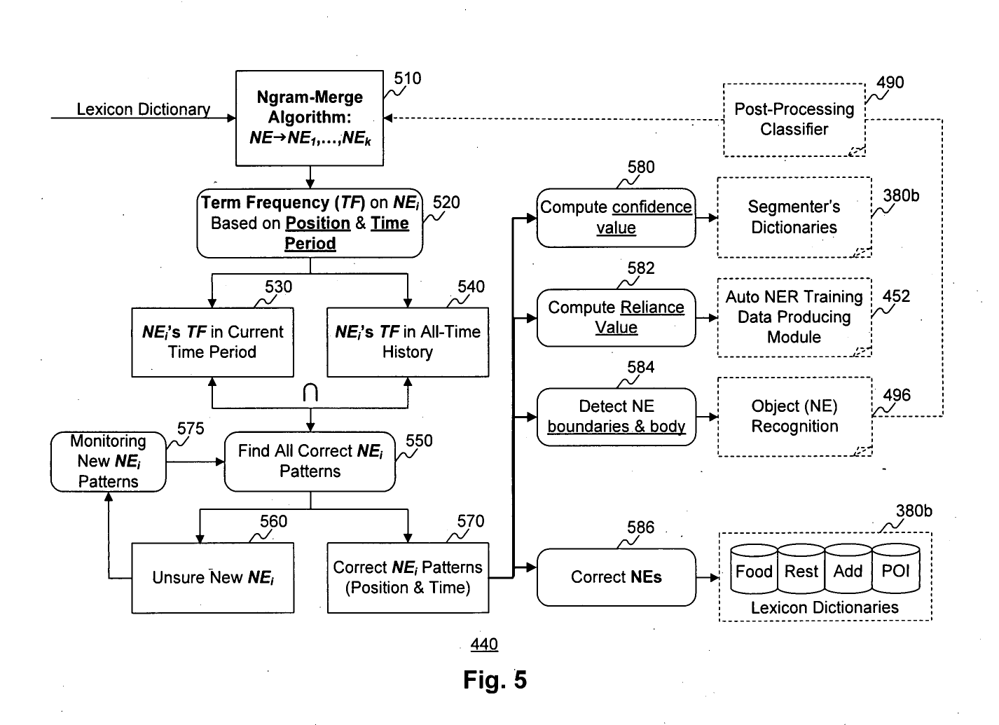

As shown in FIG. 4, intelligent NE filtering module 440 may determine the best quality objects identified by NE recognition module 480 and send the newly identified NEs (objects) to be stored in training database 360. Intelligent NE filtering module 440 may also add newly identified NEs to lexicon dictionary 380b. Intelligent NE filtering module 440 may further send identified NEs to NE recognition module 480. FIG. 5 shows a block diagram of processes performed by an exemplary implementation of intelligent NE filtering module 440, including its interfaces with other components of system 300.

As shown in FIG. 5, intelligent NE filtering module 440 may use an N-gram merge algorithm 510 to identify NE patterns. NE patterns may refer to the placement of an NE in various sentences including its word length (e.g., number of characters in a word) and relative position to other words adjacent to it. Intelligent NE filtering module 440 may determine the term frequency (TF) of various NE patterns (520) by checking the time stamps and positions in sentences associated with the NEs. TF refers to the appearance frequency of an NE or an NE pattern over a period of time. As shown in FIG. 5, intelligence NE filtering module 440 may determine each NE pattern's TF in a current time period (530), and in all time history (540) to filter out outdated NEs. Next, based on the TFs calculated, intelligence NE filtering module 440 may determine which NE patterns are correct (e.g., TFs over a threshold value) and send the selected NE patterns to be further checked by downstream processes (step 550). Intelligence NE filtering module 440 may also group the indefinite NE patterns (e.g., TFs below a threshold value) to be monitored (560 and 575). Intelligence NE filtering module 440 may then apply the monitor results when it identifies correct NE patterns (575 and 550).

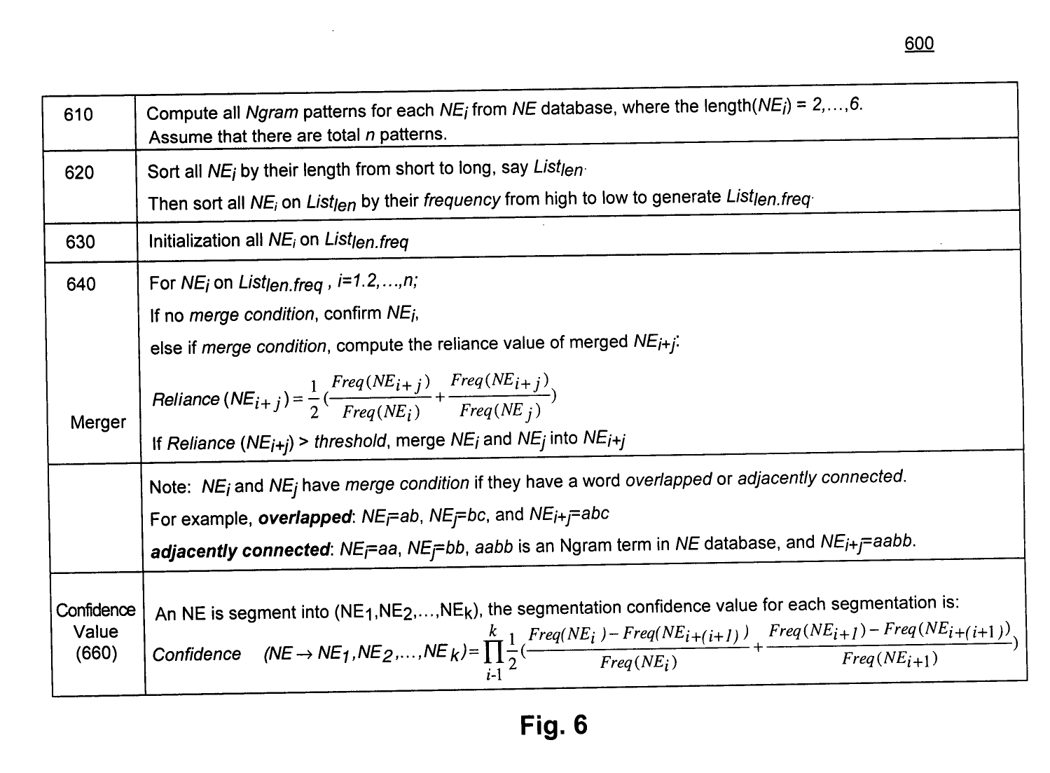

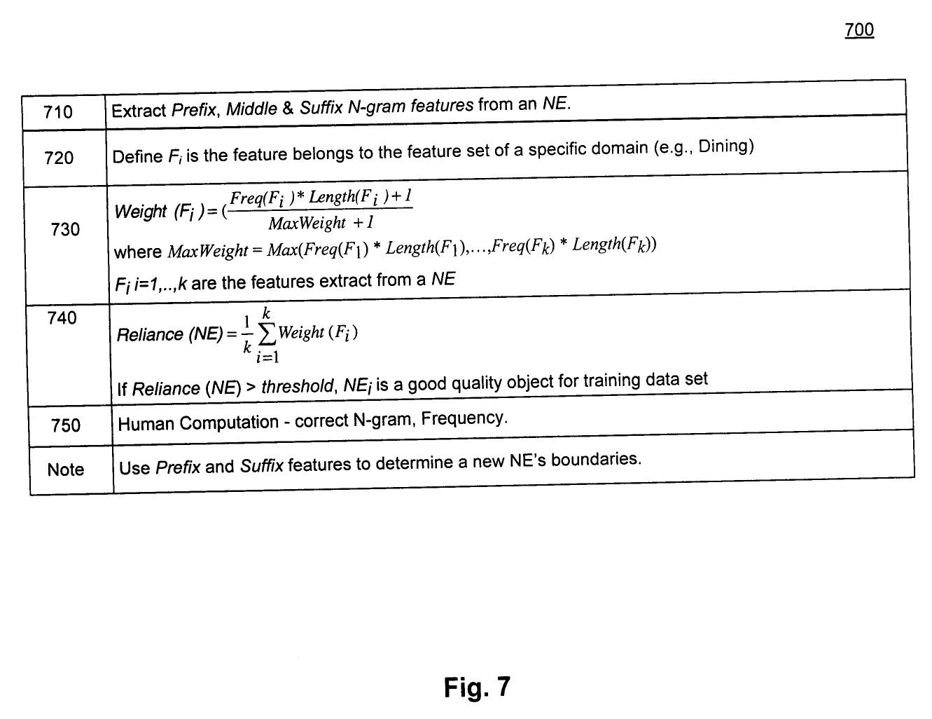

To further analyze the correct NE patterns (570), intelligence NE filtering module 440, may calculate a confidence value (580), a reliance value (582), and detect boundaries of the NE patterns (584). These further analyses are discussed below in relation to FIGS. 6 and 7. Intelligent NE filtering module 440 may then check the confidence value of an NE pattern, and send the NE pattern to be stored in lexicon dictionary 380b or to be added into training database 360 if, for example, the confidence value is above a threshold value. Intelligence NE filtering module 440 may similarly check the reliance value of an NE pattern (582) and send the NE pattern to auto NER training data producing module 452 to be stored as part of the training data stored in training database 360. Intelligence NE filtering module 440 may also determine the boundaries of an NE and calculate a confidence value of a NE boundary (584), and apply the boundary to identify correct NEs in a sentence (496). Intelligence NE filtering module 440 may then send the identified NEs to post-processing classifier 490, which in turn may categorize the NEs and send the NEs to be stored in lexicon dictionary 380b. Alternatively, intelligence NE filtering module 440 may also send correct NEs directly to lexicon dictionary 380b (586).

FIG. 6 shows an exemplary process 600 for calculating reliance values and confidence values. As shown in FIG. 6, intelligent NE filtering module 440 may identify N-gram patterns with pattern lengths being between 2 and 6 characters (610). Intelligent NE filtering module 440 may sort all NE patterns by their lengths, and then further sort the resulting list by their frequency of appearance in a document (620). Intelligence NE filtering module 440 may also calculate the NE pattern confidence value based on the appearance frequencies of the NE patterns (See FIG. 6, 660). Based on the confidence value of the NE patterns, intelligence NE filtering module 440 may check the time stamp of the first appearance of an NE pattern and its appearance frequency within a certain time period. If an NE pattern appears to be outdated, for example, intelligent NE filtering module may delete the outdated NE from training database 360 to improve the quality of training data.

Intelligence NE filtering module 440 may then check whether certain NE patterns may be merged (640). For merged NE patterns, intelligence NE filtering module 440 may determine the reliance value based on the frequency of appearance of pre-merge NEs (640). FIG. 7 shows an exemplary NE pattern reliance value calculation, which reflects how reliable an NE recognition is within a certain time period. As shown in FIG. 7, to determine a reliance value, intelligent NE filtering module 440 may first extract the prefix, middle, and suffix N-gram features from an NE (710). For example, a Chinese NE [symbol] has a [symbol] a middle [symbol] and a suffix [symbol] as its bi-gram features. Next, intelligence NE filtering module 440 may determine whether the extracted features belong to the feature set of a specific domain, such as dining (720). Intelligence NE filtering module 440 may then calculate the weight for each extracted feature based on the length of the N-gram feature and its frequency of appearance (730). Next, intelligence NE filtering module 440 may determine the reliance value based on the weights of the N-gram features (740). Further, by calculating the reliance values for the prefix, middle, and suffix, intelligence NE filtering module 440 may also determine boundaries for a new NE. As shown in FIG. 7, if the reliance value of a specific NE pattern is low, a human data processor (e.g., a data entry clerk) may be introduced to review data and correct N-gram features or the appearance frequency of a feature (750).

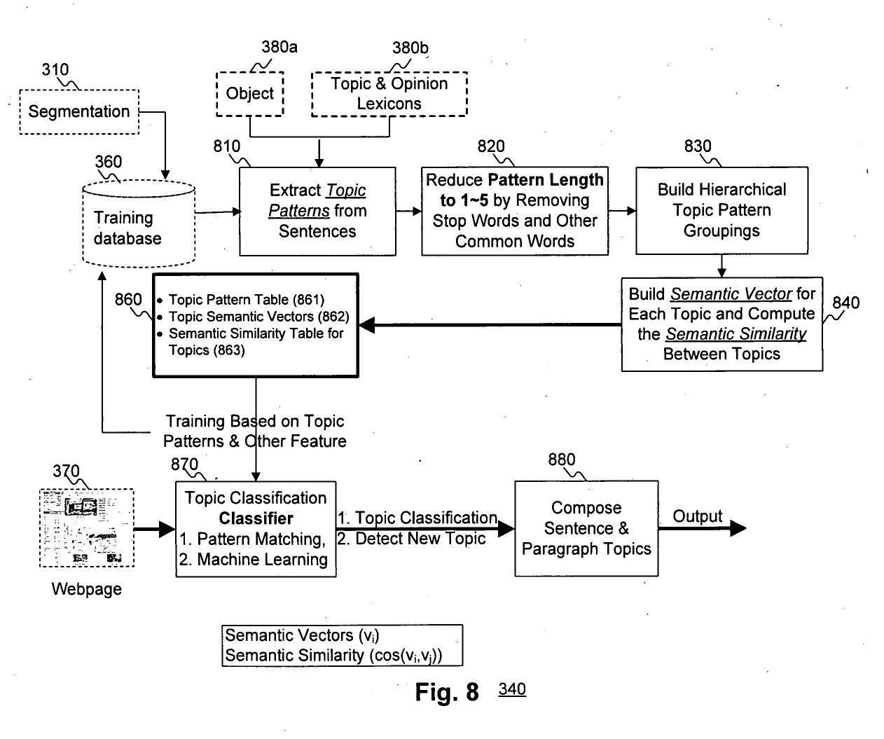

FIG. 8 shows a block diagram of an exemplary topic classification and identification module 340. Topic classification and identification module 340 may analyze segmented webpage content received from segmentation and integration module 310 to identify topics discussed by online social groups, label each sentence and paragraph with the identified topics, and send identified and labeled topics to segmentation and integration module 310 for further analysis. As shown in FIG. 8, topic classification and identification module 340 may extract topic patterns from sentences in training database 360 based on the organic object data stored in organic object database 380a and topics and opinions in lexicon dictionary 380b (810). Next, topic classification and identification module 340 may reduce the extracted topic pattern length by removing stop words and other common words that are generally not related to topics discussed in sentences (820). Next, topic classification and identification module 340 may introduce human labeling to build hierarchical topic pattern groupings (step 830). For example, referring back to FIG. 2, user review 241 may be a broad topic that includes more specific topics: ambience 242, service 243, price 244, and taste 245. Topic classification and identification module 340 may group ambience 242, service 243, price 244, and taste 245, into four topic pattern groups.

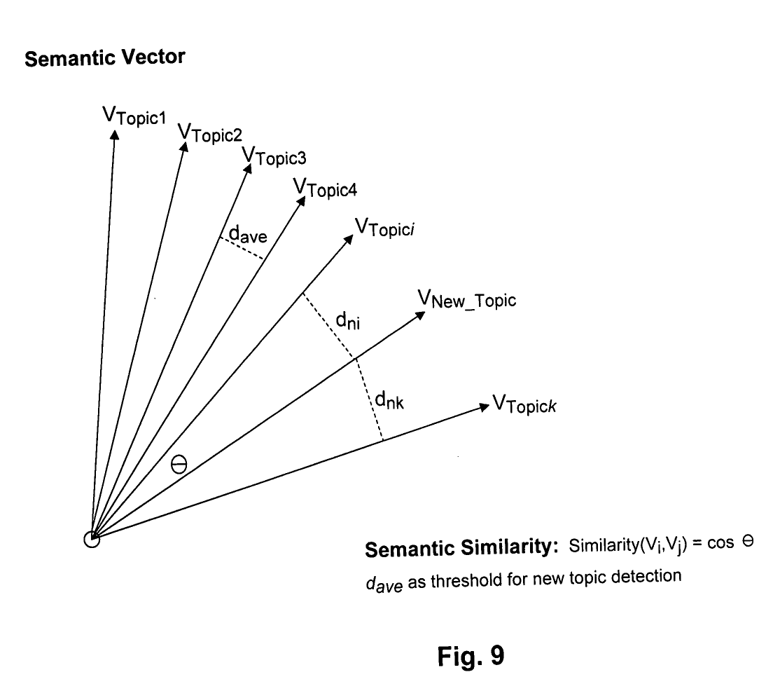

Next, topic classification and identification module 340 may compute the semantic similarity between two topics (840). FIG. 9 shows an exemplary semantic similarity calculation. As shown in FIG. 9, topics i and j may be represented by topic semantic vectors Vᵢ and Vⱼ. The semantic similarity between topics i and j may be defined as:

Similarity(Vᵢ, Vⱼ)=cos(Vᵢ, Vⱼ)=cos θ

Assuming dₐᵥₑ is the average similarity between topics in one set of topics, when topic classification and identification module 340 determines that the semantic similarity between topic l and topic n, dₙ, is greater than dₐᵥₑ, it may then decide that topic n is a new topic. In the disclosed example, topic classification and identification module 340 groups topic patterns (830) before calculating semantic similarities (840) to improve the accuracy of new topic detections.

Returning to FIG. 8, after the semantic similarities are calculated (840), topic classification and identification module 340 may store topic patterns, topic semantic vectors, and semantic similarities in one or more tables (860). As shown in FIG. 8, topic classification and identification module 340 may add identified topic patterns into training database 360 to be used as training data.

As shown in FIG. 8, a topic classifier module 870 may process an incoming segmented webpage 370 (segmented by segmentation and integration module 310), for example, by matching topic patterns stored in a topic pattern table 861, and checking semantic similarities based on data stored in a topic semantic vector table 862 and a semantic similarity table 863. Topic classifier module 870 may then classify topics in the content of webpage 370, and detect new topics in the content. Finally, topic classification and identification module 340 may label and compose the topics related to each sentence on webpage 370, and determine topics for each paragraph based on the topics of the sentences in the paragraph (880). Topic classification and integration module 340 may send the sentence topics and paragraph topics to segmentation and integration module 310 for further processing.

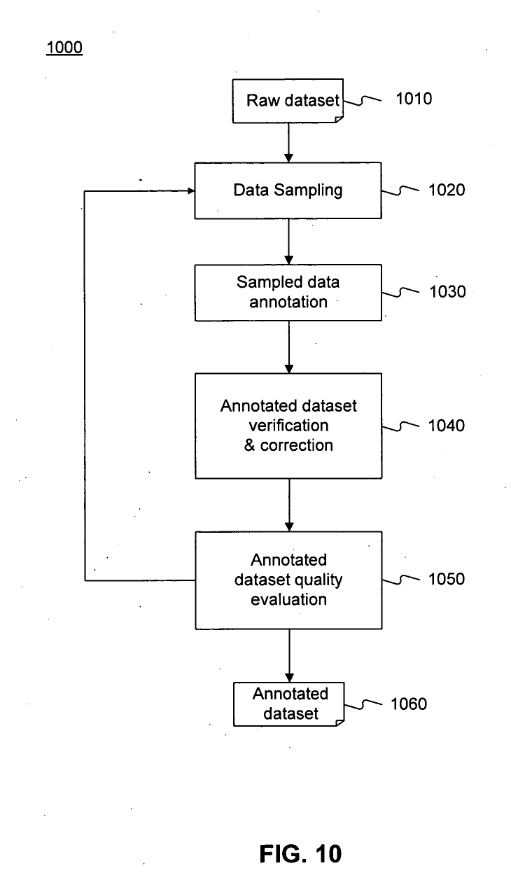

FIG. 10 shows an exemplary process 1000 for collecting and improving the quality of training datasets implemented by topic classification and identification module 340. Other modules. e.g., object recognition module 320 and opinion mining module 350, may use similar processes to improve training data quality. As shown in FIG. 10, information capture and management system 300 may start with a raw training dataset (1010), such as a large number of sentences and paragraphs collected from webpages of an online social network. For example, the raw dataset may include 50,000 sentences. Next, information capture and management system 300 may sample (e.g., sampling one of every 10 sentences) the sentences from the raw dataset (1020). Human data processors (e.g., data entry clerks) may annotate the sampled dataset, for example, by labeling topics in the 5,000 sample sentences and store the labeled data in training database 360 (1030). Information capture and management system 300 may then verify and correct the human annotated dataset (1040).

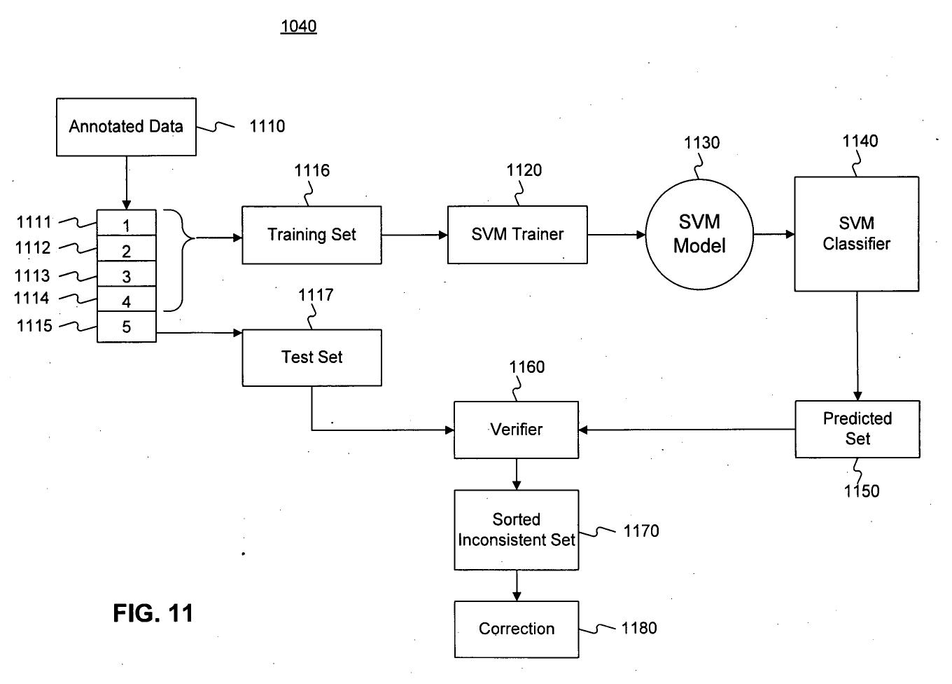

FIG. 11 shows an exemplary verification and correction process 1040 implemented by topic classification and identification module 340. Information capture and management system 300 may receive a human labeled dataset 1110 with one or more topics labeled in each sentence. Annotated dataset 1110 may include one or more labeled sentences. Topic classification and identification module 340 may then identify five sets of sentences, for example, sentence sets 1111-1115. Each sentence dataset (1111-1115) may include one or more sentences. Topic classification and identification module 340 may then use four sets of annotated datasets 1111-1114 as a training dataset 1116 and the fifth dataset 1115 as a test dataset 1117. Information capture and management system 300 may process training dataset 1116 by processing the four sentence datasets in 1116 through a Support Vector Machine (SVM) trainer 1120. SVM trainer 1120 may apply an SVM model 1130. SVM model 1130 may be a representation of data samples as points in space, mapped so that the samples of the separate categories are divided by a clear gap. Next, topic classification and identification module 340 may configure an SVM classifier 1140 using SVM parameters calculated based on training dataset 1116. Topic classification and identification module 340 may use the configured SVM classifier 1140 to predict whether the sentences in the fifth dataset 1115 would be on one or more pre-defined topics. SVM classifier 1140 may produce a predicted sentence set 1150, which may include the sentences in dataset 1115 and the predicted topics for the sentences in dataset 1115. SVM classifier 1140 may label the predict topics for the sentences in predicted set 1150. Predicted set 1150 may include confidence scores of the one or more predicted topics for sentences in dataset 1115.

As shown in FIG. 11, topic classification and identification module 340 may use a verifier 1160 to compare test dataset 1117 (which is same as dataset 1115) and predicted dataset 1150 to determine whether the human annotated fifth dataset 1115 refers to the same topics as those in the predicted dataset. If the human annotated topics and the SVM trainer predicted topics are different, verifier 1160 may send predicted set 1150 to be included in an inconsistent set to be sorted based on the confidence score associated with a predicted topic (1170). Next, a human data processor may review and correct the inconsistent set in the sequence of sorted confidence score (1180). That is, the human data processor may review and correct the wrongly predicted data point (e.g., a predicted topic) with the highest confidence score first. The human data processor may then return the corrected data to the annotated data sample file.

The exemplary process described in FIG. 11 may be repeated in various groups of annotated dataset 1110. For example, topic classification and identification module 340 may divide annotated dataset 1111 into five groups (e.g., 11111, 11112, 11113, 11114, and 11115). Topic classification and identification module 340 may use the process described above (1120, 1130, 1149, 1150, 1160, 1170, and 1180) to cross validate the annotated dataset 1111, by using datasets 11111, 11112, 11113, and 11114 as training dataset 1116, and dataset 11115 as test dataset 1117 to validate whether dataset 1111 are correctly labeled.

Returning to FIG. 10, after the annotated dataset is verified and corrected, topic classification and identification module 340 may evaluate the quality of the dataset by checking the cross validation results (e.g., correction percentage of topic predictions) to assess how accurate the SVM predictions are when compared to the human labeled sample dataset (1050). For example, topic classification and identification module 340 may set a threshold for the cross validation correct percentage. When the cross validation of the annotated dataset against the predicted set is under the threshold, topic classification and identification module 340 may return to sampling more input data (1020) and re-processing sampled data (1030 and 1040). If the cross validation correct percentage reaches the given threshold, topic classification and identification module 340 may output annotated datasets 1060 to the training database 360. As a result, the quality of the training data is tested and improved by the above process.

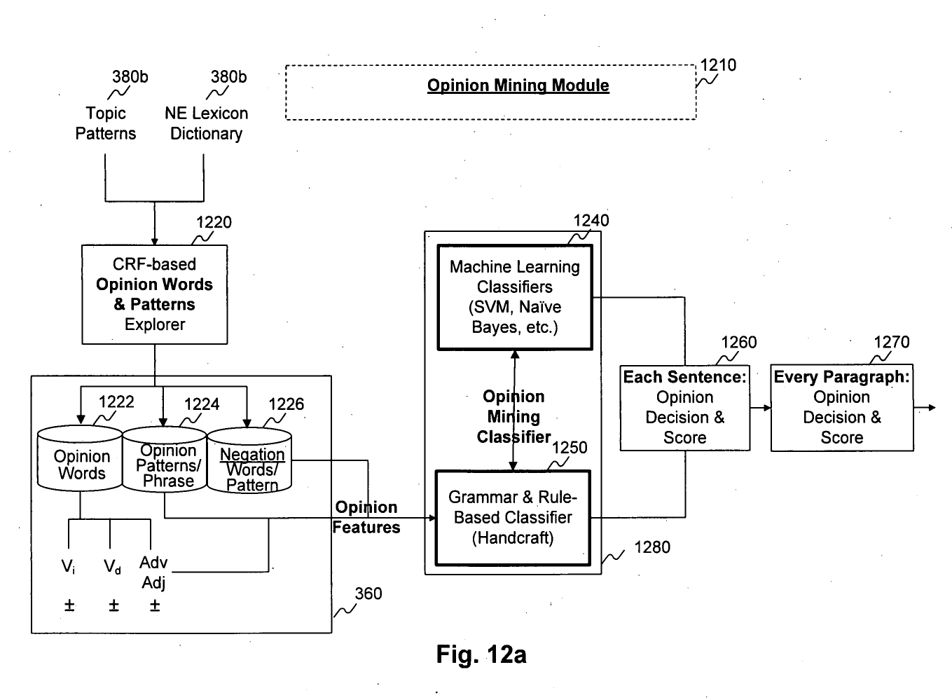

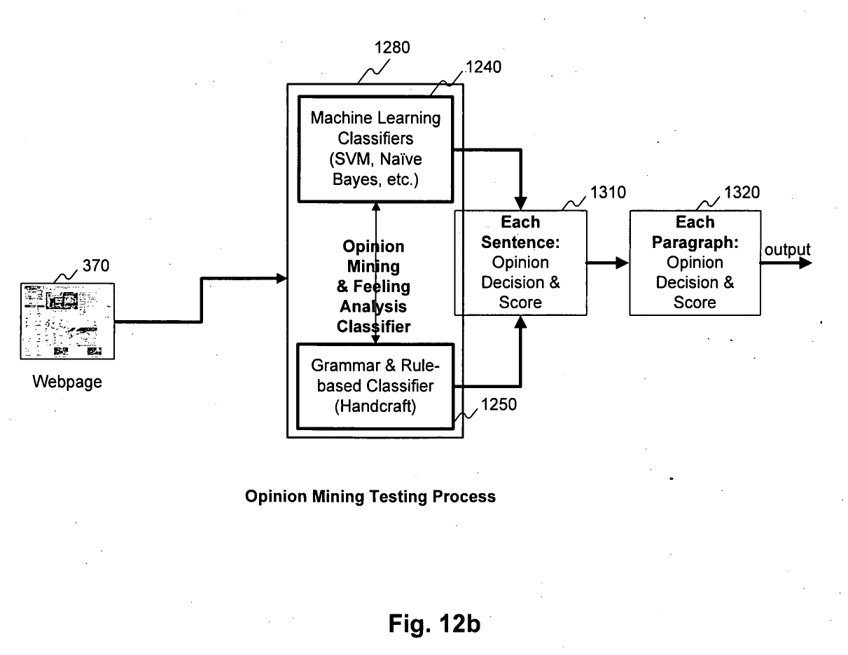

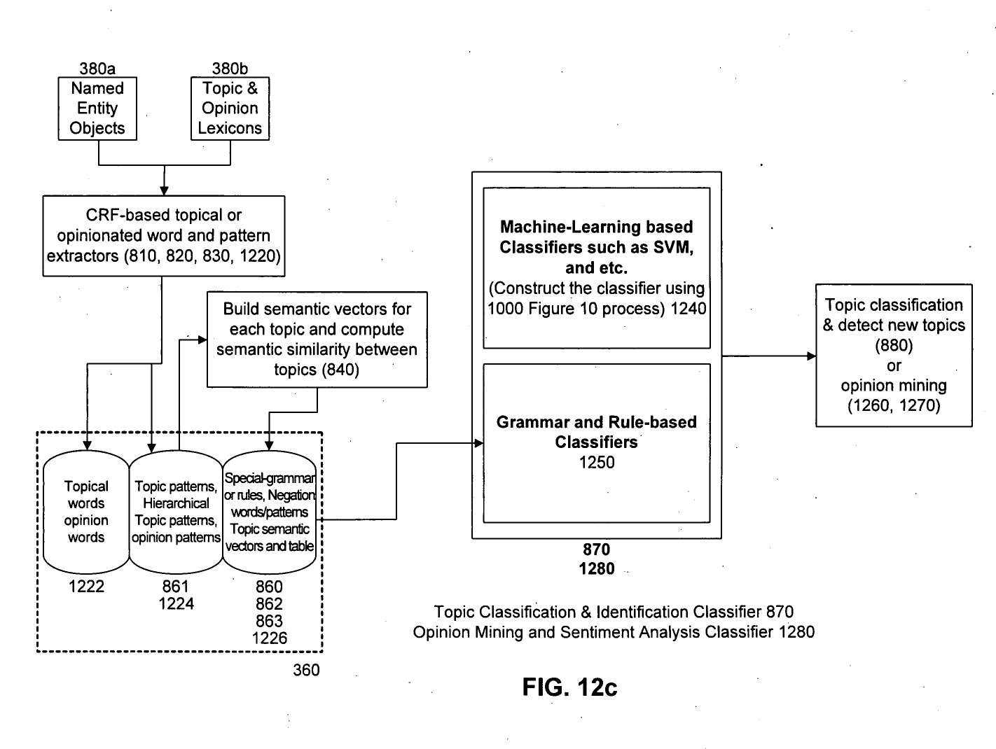

FIG. 12a shows an exemplary opinion mining process 1210 implemented by opinion mining and sentiment analysis module 350. Opinion mining and sentiment analysis module 350 may receive segmented documents and sentence topics from segmentation and integration module 310 (FIG. 3) for further processing. Opinion mining and sentiment analysis module 350 may include a CRF-based opinion words and patterns explorer module 1220. Opinion words and pattern explorer module 1220 may use the topic patterns and NEs stored in lexicon dictionary 380b (FIG. 4) in a CRF-based algorithm to identify, in the segmented documents, opinion words, opinion patterns, and negation words/pattern. Opinion words and patterns explorer module 1220 may store the opinion words, opinion patterns, and negation words/patterns in tables 1222, 1224, and 1226, which may be part of training database 360. In each table, opinion words and pattern explorer module 1220 may further classify the words/patterns into: Vᵢ (independent verbs), V_{d} (verbs that need to be followed by opinion words), Adj (adjectives that need to be followed by an opinion), and Adv (adverbs that emphasize or de-emphasize an opinion). Tables 1222, 1224, and 1226 may also store the polarity of opinions, opinion patterns/phrases labeled by human data processors.

As shown in FIG. 12a, opinion mining and sentiment analysis module 350 may identify topic-based opinionated sentences based on topic patterns stored in lexicon dictionary 380b, opinion Words 1222, opinion patterns/phrases 1224, and negation words 1226 stored in database 360. Based on the identified opinion words, opinion patterns, and negation words, opinion mining and sentiment analysis module 350 may use an opinion mining classifier 1280, which includes a machine learning classifier 1240 (for example, a classifier implementing the SVM or the Neve Bayes algorithm) and a grammar and rule-based classifier 1250, to determine whether an opinion in a sentence is positive or negative and calculate an opinion decision score based on the strength of Vᵢ, V_{d}, Adj, and Adv (1260). One example of a machine classifier 1240 is an SVM classifier 1140 as described in connection with the discussion of FIG. 11.

Rule-based classifier 1250 may use one or more plug-in modules containing language patterns and grammatical rules, such as the language patterns stored in organic object database 380a and lexicon dictionary 380b (FIG. 3), to help determine the polarity of opinions. Opinion mining classifier 1280 may also calculate a confidence value for opinion words or opinion patterns. For opinions or opinion patterns with low confidence scores, human data processors may be introduced to review and possibly correct the polarity of the opinion, and the corrected opinion words or patterns may be added to the training dataset stored in tables 1222, 1224, and 1226.

Next, opinion mining and sentiment analysis module 350 may calculate opinion decision scores of a paragraph based on the decision scores of each sentence in the paragraph (e.g., average score of sentences in a paragraph). FIG. 12b shows an exemplary opinion mining testing process implemented by opinion mining and sentiment analysis module 350. Test webpage 370 may be sent to opinion mining classifier (1240 and 1250) through segmentation and integration module 310. Based on the identified topic-based opinionated sentences 1230, opinion mining classifiers 1240 and 1250 may determine whether an opinion in a sentence is positive or negative and calculate an opinion decision score based on the strength of Vᵢ, V_{d}, Adj, and Adv (1310). Next, opinion mining and sentiment analysis module 350 may calculate opinion decision scores of a paragraph based on the decision scores of the identified opinions in each sentence of the paragraph (1320). Opinion mining and sentiment analysis module 350 may output opinions associated with a sentence, a paragraph, and opinions associated with organic objects to segmentation and integration module 310 for further processing.

Referring back to FIG. 3, object relationship construction module 330 may construct two types of relationships: the relationship between a parent object and a child object, and the relationship between two child objects. In one example, object relationship construction module 330 may use a webpage's layout and content to decide the relationship between a parent object and a child object. Object relationship construction module 330 may also use a natural language parser to analyze the relationship between two child objects.

Topic classification and identification module 340 (FIG. 8) and opinion mining and sentiment analysis module 350 (FIG. 12a) may be implemented using a similar software architecture. FIG. 12c provides an exemplary software architecture that may be used to implement both topic classification and identification module 340 and opinion mining and sentiment analysis module 350. As shown in FIG. 12c, topic classification and identification module 340 or opinion mining and sentiment analysis module 350 may extract topics or opinion words based on topic patterns and opinion words stored in organic object database 380a and lexicon dictionary 380b.

Based on the extracted opinion words and opinion patterns, an opinion mining classifier 1280 may process an incoming segmented webpage (segmented by segmentation and integration module 310), for example, by matching opinion words and opinion patterns stored in opinion words table 1222 or opinion pattern table 1224, and checking negation words or special grammatical rules based on data stored in table 1226. Tables 1222, 1224, and 1226 may be part of training database 360. Based on the identified opinion words, opinion patterns, and negation words, opinion mining and sentiment analysis module 350 may use an opinion mining classifier 1280, which includes a machine learning classifier 1240 (for example, a classifier implementing the SVM or the Naïve Bayes algorithm) and a grammar and rule-based classifier 1250, to determine whether an opinion in a sentence is positive or negative and calculate an opinion decision score based on the strength of Vᵢ, V_{d}, Adj, and Adv (1260). Rule-based classifier 1250 may use one or more plug-in modules containing language patterns and grammatical rules, such as the data stored in organic object database 380a and lexicon dictionary 380b (FIG. 3), to help determine the polarity of opinions. Opinion mining classifier 1280 may also calculate a confidence value for opinion words or opinion patterns. For opinions or opinion patterns with low confidence scores, human data processors may be introduced to review and possibly correct the polarity of the opinion, and the corrected opinion words or patterns may be added to the training dataset stored in tables 1222, 1224, and 1226.

Based on the extracted topics, a topic classifier 870 may process an incoming segmented webpage (segmented by segmentation and integration module 310), for example, by matching topic patterns stored in a topic pattern table 861, and checking semantic similarities based on data stored in a topic semantic vector table 862 and a semantic similarity table 863. Tables 861, 862, and 863 may be part of training database 360. Topic classifier module 870 may then classify topics in the content of webpage, and detect new topics in the content. Finally, topic classification and identification module 340 may label and compose topics related to each sentence on the webpage, and determine topics for each paragraph based on the topics of the sentences in the paragraph (880). Topic classification and identification module 340 may send the sentence topics and paragraph topics to segmentation and integration module 310 for further processing.

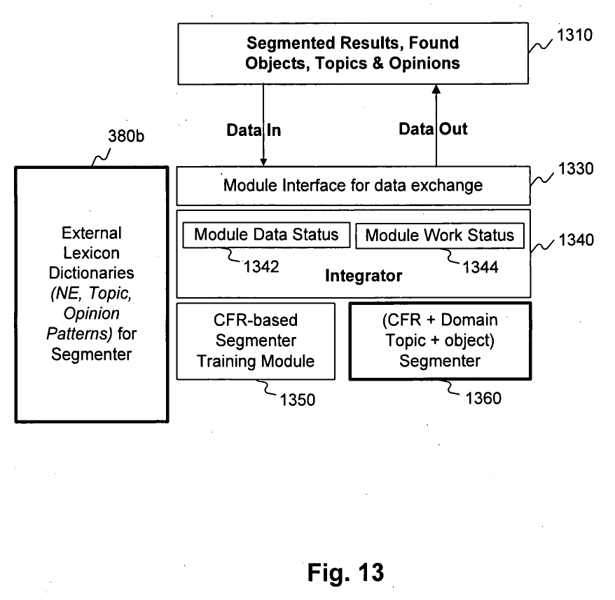

In FIG. 3, segmentation and integration module 310 may receive and process input data from all other modules, and store the captured organic object data in organic object database 380a. FIG. 13 shows an exemplary embodiment of segmentation and integration module 310.

As shown in FIG. 13, segmentation and integration module 310 may use lexicon dictionary 380b (storing NEs, topics, opinion patterns, etc.) as a plug-in for CRF-based segmenter training module 460 and segmenter 470 (see FIG. 4) to improve the accuracy of segmentation. Lexicon dictionary 380b plug-in may provide the segmenter 470 with NEs, topics, opinion patterns to help segmenter 470 recognize patterns. As described above, the content in lexicon dictionary 380b may be updated by object recognition module 320, topic classification and identification module 340, and opinion mining module 350 (through a module interface 1330). As shown in FIG. 13, these modules may also send segmented results, found objects, topics, and opinions 1310 to segmentation and integration module 310 through module interface 1330. An integration module 1340 may monitor work status of other modules (1342), and provide updates to other modules (1344). Integration module 1340 further integrates data (NEs, topics, opinion patterns, etc.) received from other modules through module interface 1330 into the organic object data model 100, and stores the object data in lexicon dictionary 380b.

It will be apparent to those skilled in the art that various modifications and variations can be made in the system and method for capturing social intelligence from online social groups and communities. For example, after considering the disclosed embodiments, one of skill in the art will appreciate that different configuration of databases may be used to store training data and the lexicon dictionary for the organic object data model. In addition, after considering the disclosed embodiments, one of skill in the art will appreciate that various machine learning algorithms may be used to identify NEs, topics, and opinions as defined in the organic object data model. Further, after considering the disclosed embodiments, one of skill in the art will also appreciate that the disclosed organic object data model may be applied to information (e.g., a large volume of data in a back-up database or paper publications) other than online social intelligence. Also, after considering the disclosed embodiments, one of skill in the art will further appreciate that the disclosed embodiments may be implemented by various software/hardware configurations by using various computer servers, computer storage medium, and software applications. It is intended that the disclosed embodiments and examples be considered as exemplary only, with a true scope of the disclosed embodiments being indicated by the following claims and their equivalents.

What is claimed is:

1. A method for capturing and organizing social intelligence data collected online using an organic object data model, the method comprising:
receiving, by a computer configured to capture and manage social intelligence information, one or more webpages containing social intelligence data;
segmenting, by the computer, content of the one or more webpages containing social intelligence data;
identifying, by the computer, named entities in the segmented content of the one or more webpages;
identifying, by the computer, topics in the segmented content of the one or more webpages;
identifying, by the computer, opinions in the segmented content of the one or more webpages;
integrating, by the computer, the identified named entities, topics, and opinions to construct an organic object data model; and
storing, by the computer, organic object data associated with the constructed organic object data model in an organic object database.

2. The method of claim 1, wherein the identifying the named entities further comprises:
training, by the computer, an object recognition module using a Conditional Random Field (CRF) based algorithm.

3. The method of claim 2, wherein the identifying the named entities further comprises:
classifying, by the computer, the identified named entities based on predetermined criteria and storing the classified named entities in a lexicon dictionary.

4. The method of claim 3, wherein the identifying the topics further comprises:
training, by the computer, a topic classification and identification module based on semantic similarities and machine-based classifications between topics.

5. The method of claim 4, wherein the identifying the topics further comprises:
classifying, by the computer, the identified topics based on topic patterns and semantic similarities stored in the lexicon dictionary.

6. The method of claim 5, wherein the identifying the opinions further comprises:
training, by the computer, an opinion mining module based on a machine learning-based algorithm, including a support vector machine.

7. The method of claim 6, wherein the identifying the opinions further comprises:
classifying, by the computer, the identified opinions using a plug-in module containing language patterns or grammatical rules.

8. A method for capturing and managing social intelligence data collected online using an organic object data model, the method comprising:
receiving, by a computer configured to capture and manage social intelligence information, one or more webpages containing social intelligence data;
segmenting, by the computer, content from the one or more webpages containing social intelligence data;
identifying, by the computer, named entities in the segmented content of the one or more webpages;
identifying, by the computer, topics in the segmented content of the one or more webpages;
identifying, by the computer, opinions in the segmented content of the one or more webpages;
integrating, by the computer, the identified named entities, topics, and opinions to construct an organic object data model; and
storing, by the computer, organic object data associated with the constructed organic object data model in an organic object database.

9. The method of claim 8, wherein the identifying the named entities further comprises:
training, by the computer, an object recognition module using a Conditional Random Field (CRF) based algorithm; and
classifying, by the computer, the identified named entities based on predetermined criteria and storing the classified named entities in the lexicon dictionary.

10. The method of claim 9, wherein the identifying the named entities further comprises:
selecting, by the computer, named entities with appearance frequency over a threshold value in a specific time period.

11. The method of claim 8, wherein the identifying the topics further comprises:
training, by the computer, a topic classification and identification module based on semantic similarities among topics.

12. The method of claim 11, wherein the identifying the topics further comprises:
classifying, by the computer, the identified topics based on topic patterns and semantic similarities stored in the lexicon dictionary.

13. The method of claim 8, wherein the identifying the opinions further comprises:
training, by the computer, an opinion mining module based on a machine learning-based algorithm, including a support vector machine.

14. The method of claim 13, wherein the identifying the opinions further comprises:
classifying, by the computer, the identified opinions using a plug-in module containing language patterns or grammatical rules.

15. A system for capturing and organizing social intelligence data collected online using an organic object data model, the system being implemented by one or more computer processors executing computer programs stored on computer readable storage medium, the system comprising:
a segmentation and integration module coupled to a training database, the segmentation and integration modules configured to receive webpages containing social intelligence data;
an object recognition module coupled to the segmentation and integration module, the object integration module configured to identify classified named entities contained in the received webpages;
a topic classification and identification module coupled to the segmentation and integration module, the topics classification and identification module configured to identify topics for each sentence and paragraph of the received webpages;
an opinion mining and sentiment analysis module coupled to the segmentation and integration module, the opinion mining and sentiment analysis module configured to determine opinions in sentences of the received webpages and opinions associated with the identified named entities or the identified topics; and
an object relationship construction module coupled to the segmentation and integration module, the object relation construction module configured to define relationships between named entities.

16. The system of claim 15, wherein the identified named entities are organic objects, and the identified topics and opinions are social attributes associated with their corresponding objects.

17. The system of claim 15, the object recognition module further comprising:
a named entity recognition module configured to identify named entities based on a Conditional Random Field (CRF) based machine learning process;
a post-processing classifier module configured to classify the identified named entities based on predetermined criteria; and
an intelligent named entity filtering module configured to update a lexicon dictionary and the training database.

18. The system of claim 15, the topic classification and identification module further comprising:
a training module configured to apply a semantic vector based machine learning method to train a topic classifier to identify topic patterns and new topics.

19. The system of claim 15, the opinion mining and sentiment analysis module further comprising:
an opinion mining classifier configured to implement a machine learning algorithm and retrieve data from a plug-in module containing grammatical rules or language patterns to determine the opinions.

20. The system of claim 15, the segmentation and integration module further comprising:
a segmentation module configured to segment the content of the received webpages based on a Conditional Random Field (CRF) based algorithm and data retrieved from a lexicon dictionary; and
an integration module configured to integrate the identified named entities received from the object recognition module, the identified topics from the topic classification and identification module, and the identified opinions from the opinion mining and sentiment analysis module to create an organic object data model.

21. The system of claim 20, wherein the organic object model includes an organic object, self-producing attributes associated with the organic object, domain-specific attributes associated with the organic object, and social attributes associated with the organic object.

22. A system for capturing and organizing social intelligence data collected online, the system being implemented by one or more computer processors executing computer programs stored on computer readable storage medium, the system comprising:
a segmentation and integration module coupled to a training database, the segmentation and integration module configured to receive webpages containing social intelligence data and support an organic object model including an organic object, self-producing attributes associated with the organic object, domain-specific attributes associated with the organic object, and social attributes associated with the organic object;
an object recognition module coupled to the segmentation and integration module, the object integration module configured to identify named entities contained in the received webpages, wherein the determined named entities are organic objects;
a topic classification and identification module coupled to the segmentation and integration module, the topic classification and identification module configured to identify topics for each sentence and paragraph of the received webpages, wherein the identified topics are social attributes associated with their corresponding organic objects;
an opinion mining and sentiment analysis module coupled to the segmentation and integration module, the opinion mining and sentiment analysis module configured to determine opinions in sentences of the received webpages and opinions associated with identified named entities, wherein the identified opinions are social attributes associated with their corresponding organic objects; and
an object relationship construction module coupled to the segmentation and integration module, the object relationship construction module configured to define relationships between organic objects.
